(19) United States
(12) Patent Application Publication
(10) Pub. No.: US 2011/0204575 A1
(43) Pub. Date: Aug. 25, 2011

(54) Piston ring

(75) Inventors: Karlheinz Langner, Sittendorf Bei Wien (AT); Reiner Ulrich, Weissach (DE); Wolfgang Geser, Gotzis (AT)

(73) Assignee: MAHLE KONIG KOMMANDITGESELLSCHAFT GMBH & CO., Rankweil (AT)

(21) Appl. No.: 12/711,757

(22) Filed: Feb. 24, 2010

(51) Int. Cl. F16J 9/06

(52) U.S. Cl. 277/473

(57) ABSTRACT

A piston ring with an upper part ring having an upper ring surface and with a lower part ring having a lower ring surface, and with a ring spring which is arranged between the part rings and acts with spring force upon these radially outward, characterized in that each of the two part rings has, on its circular-ring surface in each case facing the other part ring, a plurality of elevations arranged so as to be separated from one another by depression regions, with plateau surfaces which are parallel to the ring surfaces and are flat-planar or descend and which have in each case, the ring axis of the respective part ring, toward an inner-flank indentation which emanates, oriented parallel to the ring axis, from the plateau surfaces and runs out toward said spring axis, in each case parallel to the upper and the lower ring surface, and which has a quarter-circle-shaped cross section, the radius rv of said inner-flank indentation being 1 to 10% larger than the outer radius of the circle cross section of the common inner-flank indentation which is formed by the indentations of the part rings jointly forming the piston ring and which has a semicircular cross section.

### BACKGROUND OF THE INVENTION

### Field of the Invention

The invention relates to a three-part piston ring to be accommodated in a circumferential groove of the working piston of a piston machine. The piston ring has three open components essentially in the manner of a circular ring, to be precise with an upper part ring having an upwardly directed flat-planar upper ring surface and with a lower part ring having a downwardly directed flat-planar lower ring surface, and with a ring spring which is arranged between the two part rings and acts with spring force upon these radially outward and which contains, drawn in, a thin wire-like pin in the abutting region.

The most diverse possible proposals for piston rings and their embodiments have become known from the prior art. Thus, a simple ring of this type comprises two open flat part rings and an approximately zigzag-shaped, likewise open ring spring which is to be arranged or is arranged between these and has an approximately rectangular cross section, and has central orifices in the ring body, into which ring spring a thin guide wire likewise having a profile in the form of a circular ring is drawn on the right and left of the ring spring orifice.

Each of the approximately trapezoidal zigzag portions of the ring spring, which are arranged toward the ring axis or ring spring axis, that is to say radially inward, has in each case a tongue projecting upwardly and downwardly and having a lower height than the thickness of the flat piston rings. These tongues bear in each case against the inner-flank surface, directed radially inward toward the ring axis, of the two part rings arranged above and below the ring spring and thus ensure a radially outwardly effective action of force upon the two part rings by the ring spring.

Even though the open part rings of this known piston ring can be produced relatively simply as flat rings, the manufacture of the ring spring which acts with force radially outwardly upon the part rings and which is arranged between the two part rings is somewhat complicated in manufacturing terms.

### BRIEF SUMMARY OF THE INVENTION

The object of the present invention, then, is to provide a piston ring which is especially effective also with regard to lubrication and in which, in any situation, care is taken to ensure that the part rings bear particularly closely at their periphery against the inner wall of a working cylinder, within which the piston moves up and down in an oscillating manner, while each of the piston rings is to bear individually against the cylinder wall sealingly and thus individually ensures in each case optimally a snug bearing contact against the cylinder wall. Furthermore, there was the endeavor to ensure that the ring spring is to have as simple a build as possible and the desired full and continuous lubrication is not subjected to particular resistance at any point along the spring profile.

The subject of the invention, therefore, is, as initially mentioned, a three-part piston ring according to the independent claim.

The combination of a continuous inner indentation channel or inner-flank indentation, formed jointly on the inner surfaces of the two part rings and having an approximately semicircular cross section and directed radially toward the ring axis, in each case on the two mutually confronting elevations of the two part rings, with the somewhat smaller cross-sectional radius of the tubular spring not only ensures that the part-ring outer flanks bear snugly against the cylinder wall, but also achieves a kind of urging apart, occurring in the direction of the ring axis, of the mutually confronting plateau surfaces of the elevations of the part rings and, consequently, also actually smooth upwardly and laterally directed bearing of the respectively upper and lower ring surfaces against the respective sidewall of the piston-ring reception grooves of the working piston.

This effect of pressing down the piston rings preferably formed from cast material can be increased if, in particular, each of the two quarter-circle indentations has in its middle region a portion interrupting the quarter-circle profile and having a straight cross-sectional line, that is to say if a short piece of an (only singly curved) conical surface is arranged there within the two-dimensionally curved quarter surfaces.

Each of the two part rings has continuous non-symmetrical noses or projections which correspond to the different loads of the piston moved in an oscillating manner, which both have centrally upwardly and obliquely radially outwardly directed oblique surfaces, that is to say actually short cone (frustum) surface areas.

The preferred angular inclination of said oblique surfaces on the two externally continuous noses or projections of the part rings is as follows: Each of the oblique surfaces of the peripherally continuous projections of the two part rings has a preferably identical angle (α) to the upper and the lower ring surface of 40 to 50°.

Conventionally, during operation, the two part rings bear one against the other in a sheet-like manner with the plateau surfaces of their elevations.

It may also be, however, that, during operation, due to the radially outwardly acting pressure of the tubular spring upon the two quarter-circle indentations interrupted centrally by the abovementioned conical surface, said plateau surfaces of the elevations lift off from one another by a small amount.

It has been shown that an especially uniform lubricant distribution is achieved when the tubular spring has a narrower helical winding on both sides toward its mutually opposite ends directed toward the spring orifice than in its middle region.

As regards the form of the elevations and of the depressions, arranged between these and having a planar bottom, on the two mutually confronting surfaces of the part rings, approximately flat-trapezoidal forms are beneficial for both, the longer trapezium parallel sides of the elevations being arranged radially inward with respect to the ring axis, and the longer trapezium parallel sides of the depressions arranged between the elevations pointing radially outward between these.

According to a development, there is provision whereby the trapezium elevations have a greater surface extent than the depressions, and whereby the distance between the part rings is thus preserved during a mutual rotation of the part rings with respect to one another.

The invention is explained in more detail by means of the drawing:

### BRIEF DESCRIPTION OF THE SEVERAL VIEWS OF THE DRAWING

FIGS. 1-4 show various views of a three-part piston ring according to the prior art;

FIGS. 5-10 show various views of the upper and lower of the two part rings of the piston ring according to the invention, and also details of these, and

FIGS. 11-13 show the part rings combined into the overall piston ring and having the tubular spring arranged between them.

### DETAILED DESCRIPTION OF THE INVENTION

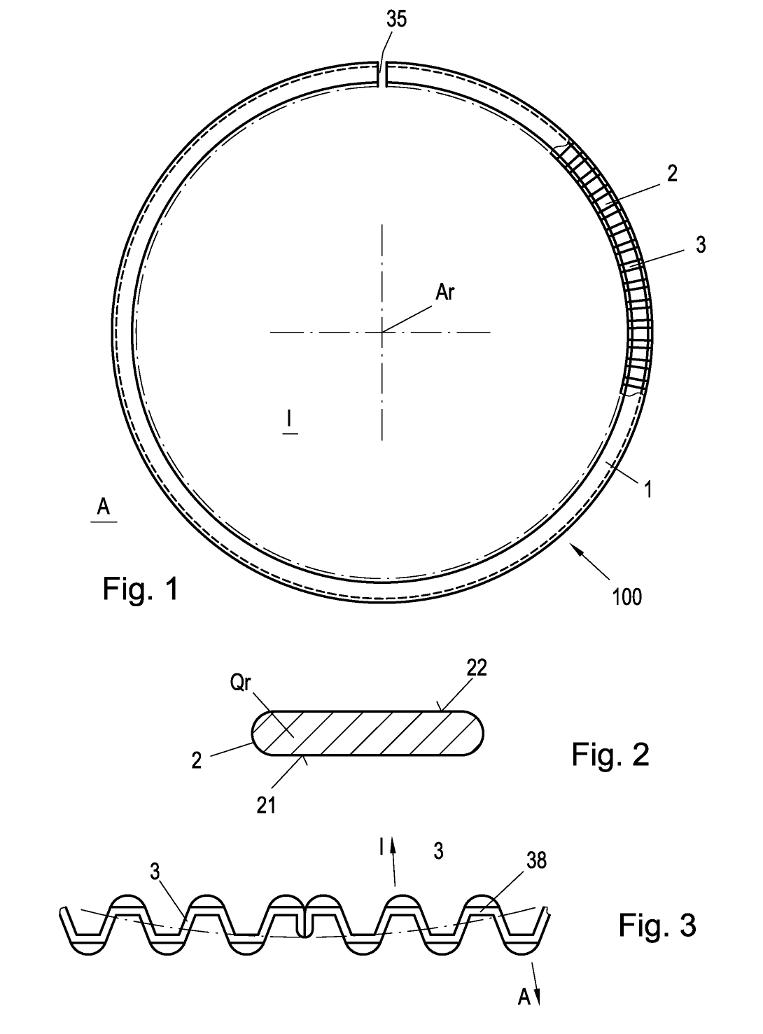

FIG. 1 shows a hitherto known three-part piston ring 100 in a view from above, and what can be seen here, virtually, is the upper part ring 1 and the expansion ring spring 3 arranged below it and having approximately a zigzag profile of trapezia lined up with one another, and also the part ring 2 arranged below it. The here very small opening gap 35 can also be seen. Also depicted there are the outer position A and inner position I and also the ring axis Ar applicable to all the part rings 1, 2 and to the ring spring 3.

FIG. 2 shows the flat-rectangular cross section Qr through one of the two part rings 2 having an identical size, cross-sectional form and dimension to one another, with its inner surface 22 pointing upward to the ring spring or in each case to the other part ring, and with the lower ring surface 21, and it shows how the part ring 2 has rounded flank surfaces on its ring flanks directed radially inward and outward.

FIG. 3 shows a top view of a portion of the ring-shaped expander spring 3 arranged between the part rings 1, 2 and having the continuously lined-up profile having alternately conventional and inverted flat-trapezoidal forms, here the flat trapezium sides which point radially inward I having spring-force transmission projections 38 which project upward and downward beyond the spring body 3 and which ensure the radial pressure of the part rings 1, 2 radially outward.

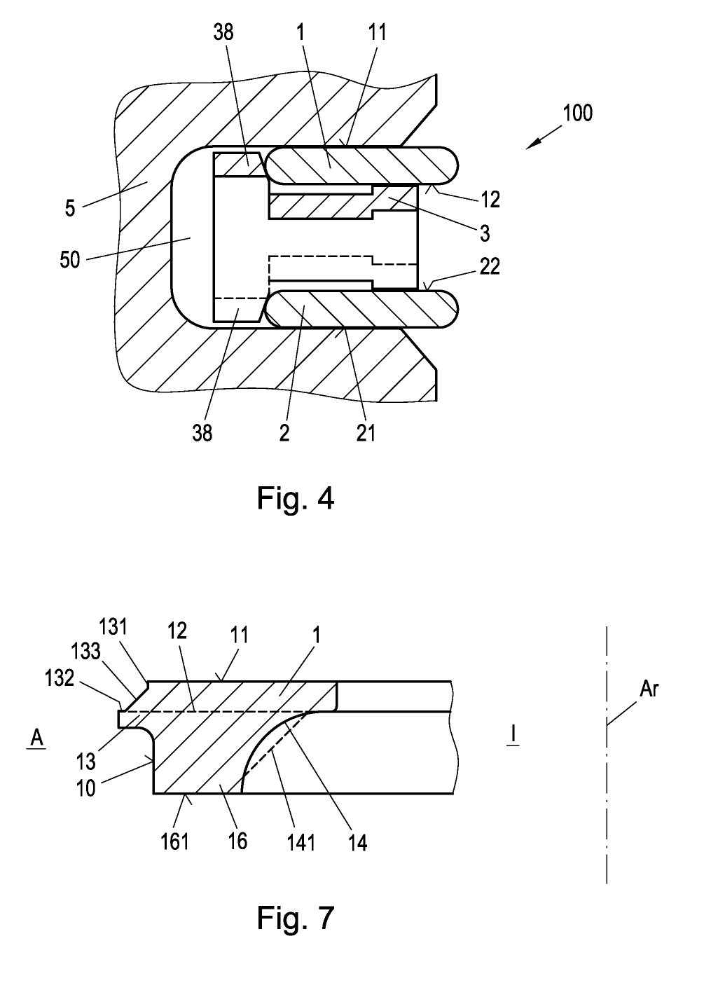

FIG. 4 shows a view of the operationally arranged piston ring 100 belonging to the prior art, with the two part rings 1 and 2 having the upper and lower ring surface 11 and 21 and the two mutually confronting ring surfaces 12, 22 and with the ring spring 3 which is arranged in the interspace between these and has essentially an approximately rectangular cross section and which has here, toward the ring axis Ar, one of the upwardly projecting expansion projections 38, by means of which the upper 1 of the two part rings 1, 2 is pressed radially outward. What can be seen there, further, is not a section, but only a view, of one of the lower expansion projections 38, by means of which the ring spring 3 acts with its force upon the lower part ring 2 and presses the latter, all-round, radially outward. What can also be seen, further, from this figure is the annular groove 50 of a working piston 5, in which annular groove the open three-part piston ring 100 is inserted.

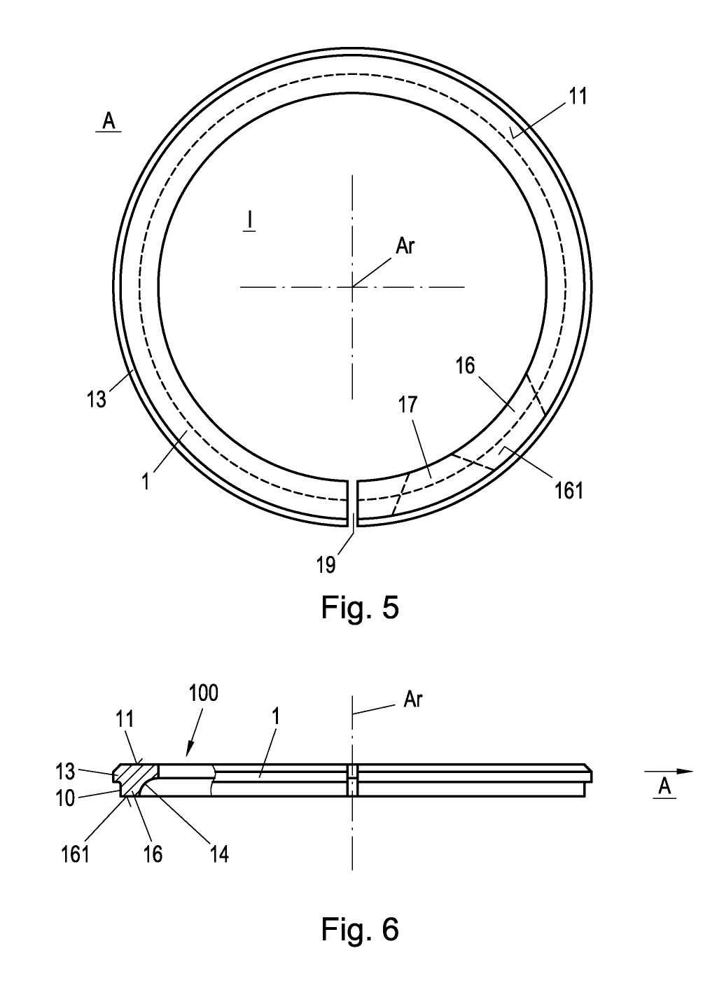

FIG. 5 shows, with the meanings of the reference symbols otherwise remaining the same, the upper part ring 1 of the piston ring 100 according to the invention in a top view, with its ring opening 19 and with its upper ring surface 11. Indicated there, further, are the flat-trapezoidal elevations 16 on its surface pointing toward the lower part ring and the plateau surfaces 161 closing off said elevations upwardly. Between these elevations 16 are arranged planar depressions 17 which likewise have a trapezoidal form and have a smaller dimension than the elevations 16.

They show, further, the outwardly pointing continuous projection 13.

FIG. 6 shows, with the meanings of the reference symbols otherwise being the same, this part ring 1 in a sectional view, the section being drawn on the left side of FIG. 6 through one of the elevations 16 with the plateau surface 161. It can be seen there how a beveled continuous projection 13 is arranged from the outer-flank surface 10 of the part ring 1. Arranged on the inside, radially with respect to the ring axis Ar, is a quarter-circle indentation 14 which commences vertically upward, essentially parallel to the ring axes, from the plateau surface 161 of the elevation 16 and which runs out parallel to the upper ring surface toward the axis Ar.

In FIG. 7, with the meanings of the reference symbols otherwise remaining the same, the section drawn through the elevation 16 of the part ring 1 is shown on an enlarged scale: what can be gathered quite clearly here is the cross-sectional form of the continuous projection 13 which projects radially outward from the part ring 1 and which, commencing with a small edge 131 on the upper part-ring surface 11, merges into a short oblique, that is to say cone frustum surface 133 which then terminates downwardly again in a small edge 132.

What can be seen very clearly from this figure is the quarter-circle indentation 14 which extends continuously around on the inner flank of the part ring 1, that is to say actually on the elevations 16, and which finally, rounded slightly, terminates on the inner flank of the part ring 1. Also depicted there is a possible conical surface 141 in the middle region of the quarter-circle indentation 14.

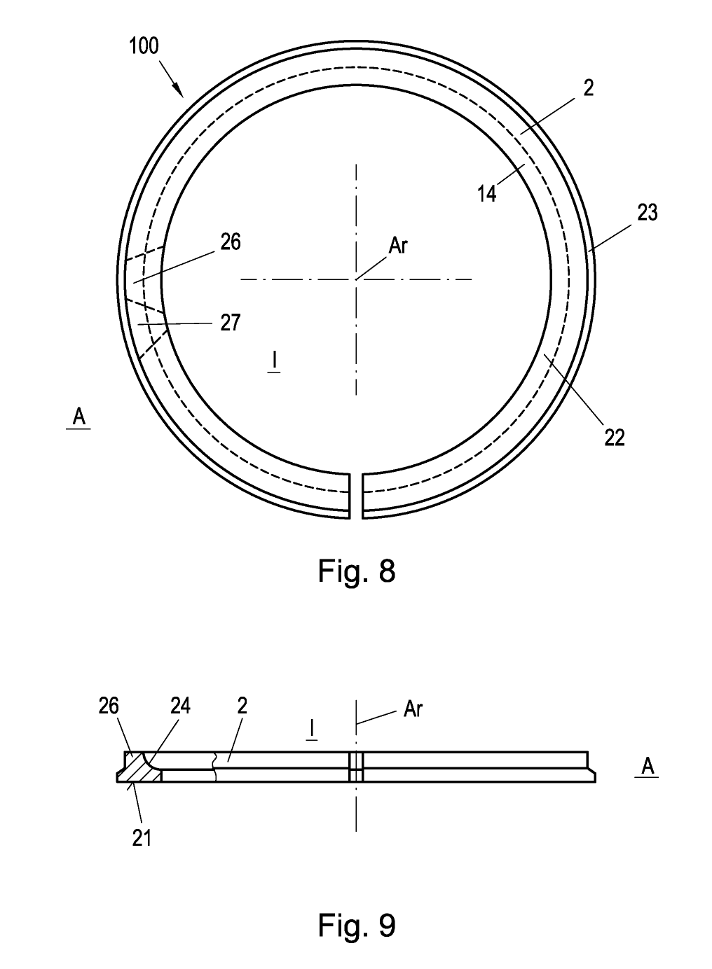

FIGS. 8 to 10 show, with the meanings of the reference symbols otherwise remaining the same, closely similar views of the lower part ring 2, built in a very similar way per se, with the lower, preferably ground ring surface 21, with the flat-trapezoidal elevations 26 which likewise point upward and are formed with plateau surfaces 261 and which are arranged in the same way and with the same height and size on the surface 22, and with the trapezoidal depressions 27 lying between said elevations and having a smaller dimension.

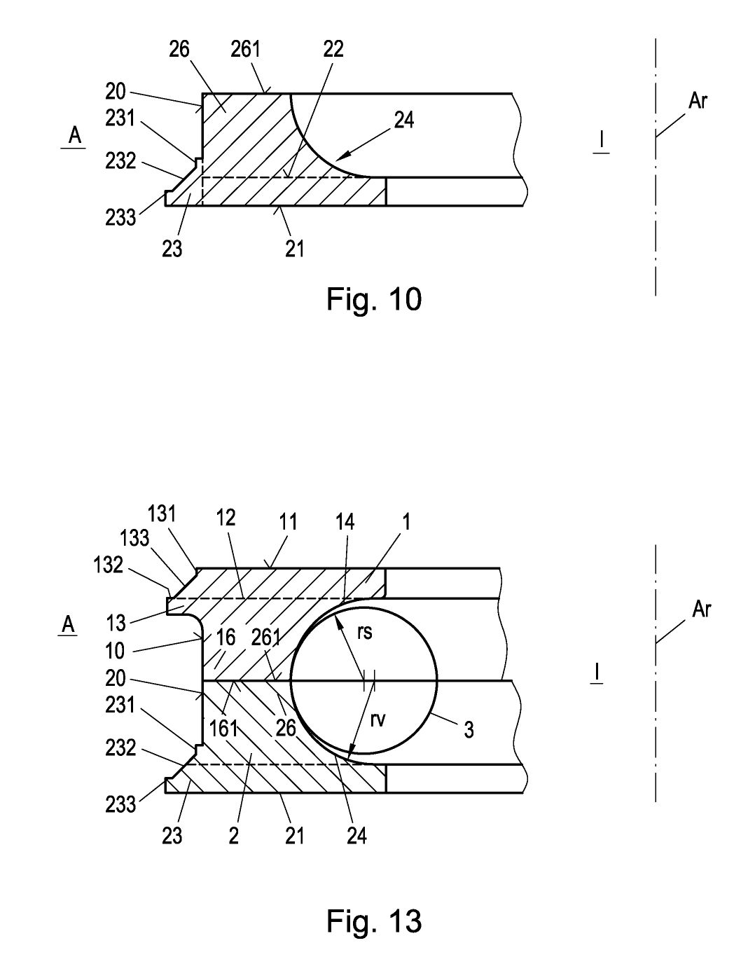

It can be seen very clearly there, particularly from FIG. 10, how the lower outer edge of the lower part ring 2 is designed with a continuous projection 23 which, commencing with a small edge 233 on the lower ring surface 21, merges into an oblique surface 232 which is directed outward and upward and which itself also merges into a somewhat projecting edge 231, from where a setback to the outer-flank surface 20 of the part ring 2 occurs.

In FIG. 10, there is provided, radially on the inside, an inner-surface indentation 24 which has, perpendicularly from the ring surface 22 or from one of the elevations 16 formed in the same way there, or its surface 261, a quarter-circle-shaped profile and is directed toward the ring axis Ar and which runs out parallel to the lower ring surface 21.

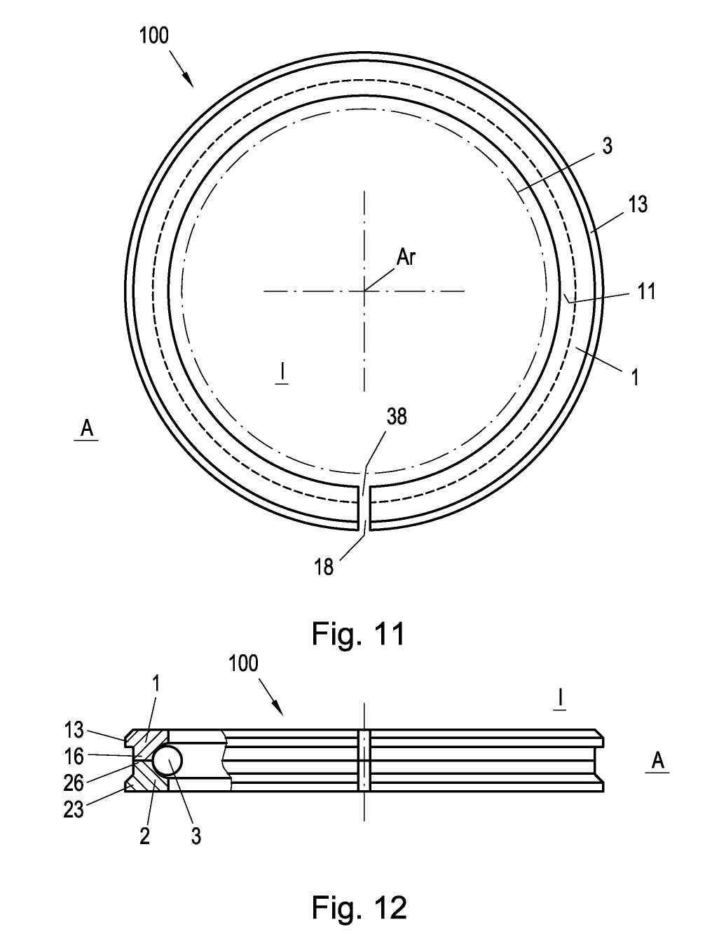

Finally, FIGS. 11 to 13 show the entire piston ring 100 composed of the above-described upper and lower part rings 1, 2, here the plateau surfaces 161, 261 of the flat-trapezoidal elevations 16, 26 bearing one against the other in a sheet-like manner, and there being formed, radially inward, an essentially approximately semicircular continuous indentation 1424 which is formed overall from the two inner-flank indentations 14, 24 having a quarter-circle cross section and into which is inserted a simple ring or tubular spring 3 likewise open at one point and having a radius rs of the spring body which is 2 to 10% smaller than the radius rv of the quarter-circle indentations 14, 24 on the inner flanks of the elevations 16 and 26 of the two part rings 1 and 2.

1-10. (canceled)

11. A piston ring, comprising:
three open components disposed substantially in a circular ring, said components including:
an upper part ring having an upwardly directed, flat-planar upper ring surface and an inner ring surface;
a lower part ring having a downwardly directed, flat-planar lower ring surface and an inner ring surface; and
a ring spring disposed between said upper and lower part rings and acting with radially outward spring force upon said upper and lower part rings, and containing, drawn in, a thin wire pin in an abutting region;
each of said upper and lower part rings having, on its respective inner ring surface a plurality of elevations separated from one another by depression regions;
said elevations having plateau surfaces parallel to said ring surfaces and flat-planar or descending inwardly or outwardly with respect to said ring surfaces by an amount of 0.1 to 0.2 mm; and
said elevations having, formed toward a ring axis of the respective said part ring, an inner-flank indentation emanating, oriented parallel to said ring axis, from said plateau surfaces and running out toward said spring axis to become in each case parallel to said upper ring surface and said lower ring surface, respectively, said inner-flank indentation having a substantially quarter-circle-shaped cross-sectional profile and said inner-flank indentations of said upper and lower ring parts together forming the piston ring forming a common indentation with a substantially semicircular cross section and a given indentation radius;
said given indentation radius being 1 to 10% greater than an outer radius of a circle cross section of said ring spring disposed in said common indentation formed by said upper and lower ring parts.

12. The piston ring according to claim 11, wherein said plurality of elevations are formed equidistant from one another.

13. The piston ring according to claim 11, wherein the given indentation radius of said quarter-circle inner-flank indentation is 2 to 5% larger than the outer radius of said ring spring.

14. The piston ring according to claim 11, wherein each of said inner-flank indentations of said elevations of said upper and lower part rings has, in its middle portion, a segment of straight cross section which has substantially a chord-like profile and which amounts to a maximum of 50% of the respective overall cross-sectional quarter-circle length.

15. The piston ring according to claim 11, wherein said upper part ring has, on or in a region near said upper ring surface, a peripherally continuous projection projecting radially outward, with an upwardly directed oblique surface arranged between two likewise continuous projection edges and with an underside flank surface running parallel to said upper ring surface and returning to the outer flank of said upper part ring.

16. The piston ring according to claim 15, wherein said lower part ring has a radially outwardly projecting peripherally continuous projection commencing on said lower ring surface of said lower part ring, with an upwardly directed oblique surface arranged between two continuous projection edges and with a top-side flank surface returning to the outer flank of said lower part ring.

17. The piston ring according to claim 16, wherein each of said oblique surfaces of said peripherally continuous projections of said upper and lower part rings has an identical angle to the upper and the lower ring surface of 40 to 50°.

18. The piston ring according to claim 11, wherein, in an operating state, said upper and lower part rings bear one against the other in a sheet-like manner with said plateau surfaces of said elevations on the mutually facing inner surfaces of said part rings.

19. The piston ring according to claim 11, wherein, in an operating state, said upper and lower part rings are held, spaced apart from one another at a short distance by way of said ring spring urging said upper and lower part rings radially outward.

20. The piston ring according to claim 11, wherein said short spacing distance between said upper and lower part rings is 0.1 to 0.2 mm.

21. The piston ring according to claim 11, wherein said ring spring has narrower helices or a larger number of turns on the two sides of its opening or abutting point than in a remaining region.

22. The piston ring according to claim 11, wherein said elevations have a substantially trapezoidal form in a top view, with short trapezium parallel sides of the depressions, ultimately constituting radial passages and having a corresponding trapezoidal counter-form, between the elevations being directed inward toward the ring axis, and with long trapezium parallel sides being directed outward toward a periphery of said part rings.

23. The piston ring according to claim 11, wherein said elevations and said depressions formed therebetween are designed, in a top view, on the mutually facing surfaces of said part rings in each case with trapezoidal forms identical to one another, although the trapezia of the elevations have longer parallel sides and thus a greater surface extent than the depressions arranged therebetween.
